(19) United States
(12) Patent Application Publication
(10) Pub. No.: US 2023/0010857 A1
(43) Pub. Date: Jan. 12, 2023

(54) WIRE ELECTRIC DISCHARGE MACHINING DEVICE AND SHEET USED IN WIRE ELECTRIC DISCHARGE MACHINING DEVICE

(71) Applicants: YASUNAGA CORPORATION, Iga-shi (JP); CANON MARKETING JAPAN KABUSHIKI KAISHA, Tokyo (JP)

(72) Inventor: Yosuke Kiryu, Iga-shi (JP)

(21) Appl. No.: 17/756,824

(22) PCT Filed: Dec. 8, 2020
(86) PCT No.: PCT/JP2020/045688

§ 371 Date: Jun. 3, 2022

(30) Foreign Application Priority Data
Dec. 26, 2019 (JP) 2019-236558

(51) Int. Cl. B23H 7/02

(52) U.S. Cl. CPC B23H 7/02

(57) ABSTRACT

Provided is a wire electric discharge machining device which machines a workpiece by electric discharge between a wire and the workpiece, the wire electric discharge machining device includes a jig holding the workpiece, and a cover layer disposed in a fixing part of the jig that faces the workpiece, the cover layer corresponds to a sheet having conductivity and also having an adhesive property to adhere to the workpiece and the jig, and the sheet includes a conductive layer formed of a copper foil, and a conductive adhesive layer combined with this conductive layer.

### CROSS-REFERENCE TO RELATED APPLICATIONS

The present application is a § 371 national phase entry of PCT International patent application Serial No. PCT/JP2020/045688, filed Dec. 8, 2020, and further claims priority to Japanese patent application Ser. No. 2019-236558, filed Dec. 26, 2019.

### TECHNICAL FIELD

The present invention relates to a wire electric discharge machining device and a sheet used in this wire electric discharge machining device, and more particularly relates to a wire electric discharge machining device including a jig holding a workpiece and a sheet put between the workpiece and the jig.

### BACKGROUND ART

In recent years, a method of cutting out a plurality of workpieces of a semiconductor material, a solar cell material, a hard material or the like simultaneously in a short time by electric discharge machining has been developed.

For example, in a wire electric discharge machining device, to cut out a workpiece in a thin plate shape, electric discharge machining of the workpiece is performed by running a wire to which a voltage is applied via a power feed contact and bringing the workpiece closer to the wire to generate a discharge phenomenon.

Patent Document 1 describes that a workpiece is cut into thin pieces by performing electric discharge machining of the workpiece with a plurality of running wires. Such electric discharge machining is usually performed by running a wire in a machining tank filled with water and immersing the workpiece into the machining tank.

The wire electric discharge machining device includes a jig movable in a state of holding the workpiece, for bringing the workpiece closer to the wire in the machining tank. This jig has a function of holding the workpiece, also needs to be energized with the workpiece, and is therefore formed of a material having conductivity, for example, a metal material such as stainless steel or aluminum.

Specifically, the workpiece held by the jig made of a metal is immersed together with the jig into water in the machining tank and brought closer to the wire in the machining tank. As a result, electric discharge occurs between the workpiece and the wire, and machining of the workpiece proceeds.

### PRIOR ART DOCUMENT

### Patent Document

Patent Document 1: Japanese Patent Laid-Open No. 2010-260151

### SUMMARY OF THE INVENTION

### Problems to be Solved by the Invention

It is provided that when a wire electric discharge machining device is driven, a workpiece might be cracked while being machined. As results of observing a contact surface of the cracked workpiece with a jig, and a contact surface of the jig with the workpiece, deposits and scratch marks are confirmed. It has been confirmed that such a deposit is an oxide of a material of the jig. It has been also confirmed that such a scratch mark is an abnormal electric discharge mark due to occurrence of electric discharge, which is not to occur originally, between the workpiece and the jig.

As a cause for such a defect as described above, the following is considered. The jig holding the workpiece is immersed into water, and hence different materials having different conductivities are in contact with each other in the presence of water. It is considered that electrolytic corrosion occurs. Additionally, it is considered that the electrolytic corrosion is promoted due to energization for electric discharge machining. It is further considered that as the electrolytic corrosion proceeds in this way, an oxide film is formed between the workpiece and the jig. This oxide film is electrically insulative, and hence an area of a portion involved in energization from the workpiece to the jig, that is, an energization area reduces, to raise an electrical resistance value. Then, the energization might be partially condensed. It is considered that abnormal electric discharge eventually occurs between the workpiece and the jig, to generate cracks in the workpiece and abnormal electric discharge marks.

Also, the contact surface of the workpiece with the jig and the contact surface of the jig with the workpiece are not completely flat surfaces, and there are fine irregularities. Consequently, it is considered that there is a fine gap between the workpiece and the jig. If a high voltage is applied between the workpiece and the jig separated from each other by the gap, unplanned electric discharge might occur between the workpiece and the jig, to generate cracks in the workpiece and form the abnormal electric discharge marks.

As described above, when the workpiece is cracked, product yield decreases. Also, if defect occurs in the jig, holding of the workpiece and energization with the workpiece are adversely affected, and the jig needs to be repaired or replaced. An operation ratio of the wire electric discharge machining device might drop.

Embodiments of the present invention can provide a wire electric discharge machining device which can suppress occurrence of abnormal electric discharge between a workpiece and a jig and thus prevent decrease in product yield and drop in operation rate, and a sheet used in this wire electric discharge machining device.

### Means for Solving the Problems

An aspect of the present invention is directed to a wire electric discharge machining device which machines a workpiece by electric discharge between a wire and the workpiece, including a jig holding the workpiece, and a cover layer disposed in a part of the jig that faces the workpiece, wherein the cover layer has conductivity and also has an adhesive property to adhere to the workpiece and the jig.

A configuration is preferable where the cover layer contains a resin base material having adhesiveness, and a conductive filler dispersed in the resin base material.

Another configuration is preferable where the resin base material is formed in a sheet shape.

Still another configuration is preferable where the cover layer contains a foil made of a metal and that faces the workpiece.

A further configuration is preferable where the foil is a foil made of any one of metals consisting of copper, silver, gold, and aluminum.

Another aspect of the present invention is directed to a sheet used in a wire electric discharge machining device which machines a workpiece by electric discharge between a wire and the workpiece, the sheet being put between the workpiece and a jig holding the workpiece, the sheet including a conductive layer formed of a metal material, and an adhesive layer containing a conductive material.

A configuration is preferable where in the conductive layer, the metal material is any one of copper, silver, gold, and aluminum.

Another configuration is preferable where the jig includes a suction part that sticks the workpiece, the sheet includes a region overlapping with the suction part that is in a surface of the jig, and at least a part of the region is removed.

Still another configuration is preferable where a thickness of the sheet is 70 µm or less.

A further configuration is preferable where a planar view shape of the sheet is larger than a planar view shape of the part of the jig that faces the workpiece.

### Advantageous Effects of the Invention

According to embodiments of the present invention, a wire electric discharge machining device is a wire electric discharge machining device which machines a workpiece by electric discharge between a wire and the workpiece, including a jig holding the workpiece, and a cover layer disposed in a part of the jig that faces the workpiece, wherein the cover layer has conductivity and also has an adhesive property to adhere to the workpiece and the jig. The cover layer exists to fill in a gap between the workpiece and the jig. Consequently, occurrence of abnormal electric discharge between the workpiece and the jig can be suppressed. Consequently, according to the present invention, the wire electric discharge machining device which can prevent decrease in product yield and drop in operation rate can be provided.

Also, in the wire electric discharge machining device of the present invention, the cover layer contains a resin base material having adhesiveness, and a conductive filler dispersed in the resin base material. This can improve conductivity and adhesive property between the jig and the workpiece.

Further, in the wire electric discharge machining device of the present invention, the resin base material is formed in a sheet shape. This makes it easier to perform a work when placing the cover layer in the jig.

Additionally, in the wire electric discharge machining device of the present invention, the cover layer contains a foil made of a metal and that faces the workpiece. This makes it easier to take the workpiece away from the jig while securing conductivity between the jig and the workpiece.

Also, in the wire electric discharge machining device of the present invention, the foil is a foil made of any one of metals consisting of copper, silver, gold, and aluminum. The foil made of the metal is excellent in conductivity and can easily secure the conductivity between the jig and the workpiece. In particular, the foil made of copper is highly conductive, inexpensive and easy to obtain, so that cost required for replacement of the cover layer or the like can be reduced while maintaining the conductivity.

Further, a sheet of the present invention is a sheet used in a wire electric discharge machining device which machines a workpiece by electric discharge between a wire and the workpiece, the sheet being put between the workpiece and a jig holding the workpiece, the sheet including a conductive layer formed of a metal material, and an adhesive layer containing a conductive material. Consequently, excellent conductivity and adhesive property are exerted between the workpiece and the jig, and occurrence of abnormal electric discharge between the workpiece and the jig can be suppressed.

Also, in the sheet of the present invention, in the conductive layer, the metal material is any one of copper, silver, gold, and aluminum. These metals are excellent in conductivity and can easily secure the conductivity between the jig and the workpiece.

Further, the sheet of the present invention includes a region overlapping with a suction part that is in a surface of the jig, the jig including the suction part that sticks the workpiece, and at least a part of the region is removed. Consequently, when the workpiece is suctioned and held by the jig, the sheet is prevented from inhibiting the suctioning and contributes to securing of a satisfactory holding force.

Additionally, a thickness of the sheet of the present invention is 70 µm or less. This can shorten a distance between the workpiece and the jig and contribute to lowering of an electrical resistance value between the workpiece and the jig.

Also, a planar view shape of the sheet of the present invention is larger than a planar view shape of the part of the jig that faces the workpiece. This can improve an adhesive property between the workpiece and the jig and prevent water from permeating between the workpiece and the jig.

The present summary is provided only by way of example, and not limitation. Other aspects of the present invention will be appreciated in view of the entirety of the present disclosure, including the entire text, claims and accompanying figures.

### BRIEF DESCRIPTION OF THE DRAWINGS

FIG. 1 is a side view schematically showing a configuration of a wire electric discharge machining device according to one embodiment.

FIG. 2 is a perspective view showing an elevating table and a jig.

FIG. 3 is a side view schematically showing a state seen in an arrow III direction of FIG. 2.

FIG. 4 is a cross-sectional view schematically showing a state where a workpiece is held by the jig.

FIG. 5 is a front view schematically showing the jig on which a sheet is disposed.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### MODE FOR CARRYING OUT THE INVENTION

Hereinafter, description will be made as to one embodiment of a wire electric discharge machining device 2 according to the present invention with reference to the drawings.

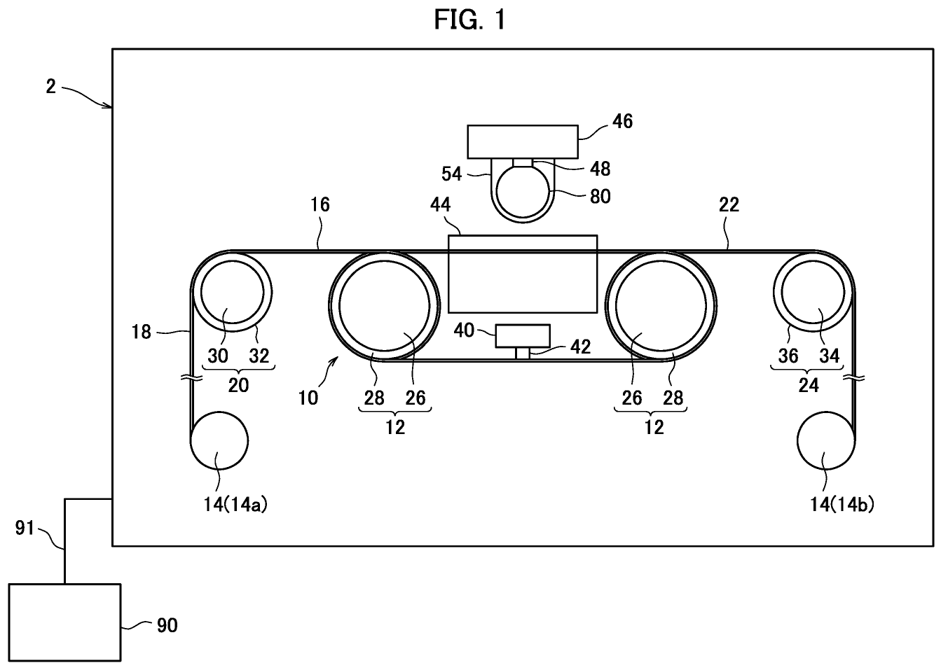

As shown in FIG. 1, the wire electric discharge machining device 2 is connected to a power supply device 90 via a power supply wiring 91 and includes a roller unit 10.

The power supply device 90 is a device that supplies power required for the wire electric discharge machining device 2 to function.

The roller unit 10 includes a pair of main rollers 12 and 12. These main rollers 12 can be rotated forward and in reverse by a motor (not shown) and are arranged away from each other in a horizontal direction.

The roller unit 10 is combined with a pair of wire reels 14 and 14, and each of these wire reels 14 can also rotate forward and in reverse and is used as a feed reel or a take-up reel depending on a rotating direction of the reel. For example, in a case of running a wire 16 in a certain direction, the wire reel 14 functioning as a feed reel 14a feeds the wire 16 with the rotation of the reel, and the fed wire 16 is guided along a one-side wire path 18 toward the roller unit 10. In this one-side wire path 18, a first guide roller 20 as a direction change roller is disposed in the vicinity of the roller unit 10. Then, the wire 16 is hung on the first guide roller 20 to change a running direction of the wire 16. Consequently, the wire 16 is guided to the roller unit 10 via the first guide roller 20.

The wire 16 guided by the roller unit 10 is wound around and hung on the pair of main rollers 12 and 12 a plurality of times, then guided out from the roller unit 10 through another-side wire path 22 and taken up to the wire reel 14 functioning as a take-up reel 14b. Here, also in the other-side wire path 22, a second guide roller 24 is disposed as a direction change roller similar to the first guide roller 20 in the vicinity of the roller unit 10. Then, the wire 16 is hung on the second guide roller 24 to change the running direction of the wire 16 toward the take-up reel 14b.

Note that the wire reels 14 and 14 are coupled to traverse control mechanisms (not shown), respectively. Each of the traverse control mechanisms moves the wire reel 14 on a side corresponding to the mechanism back and forth in an axial direction of the reel, so that the wire 16 can be stably fed or taken up.

Each of the above main rollers 12 includes a columnar core body 26 formed of a metal material, and a surface part 28 covering an outer circumferential surface of the core body 26.

In the surface part 28 of the main roller 12, that is, the outer circumferential surface of the main roller 12, a plurality of grooves are provided. Each of the grooves is provided to receive the wire 16 and position the wire 16 in place, and the grooves are formed in predetermined intervals and number in such a way that a workpiece 80 can be machined with a desired thickness. One wire 16 fed out from the feed reel 14a is inserted into the plurality of grooves provided in the surface part 28 of the main roller 12 while being wound around and hung on the pair of main rollers 12 and 12 a plurality of times to be positioned in place. Consequently, a plurality of rows of wires 16 are arranged side by side. Then, a tip end of the wire 16 guided out from the main roller 12 is taken up onto the take-up reel 14b.

The pair of main rollers 12 and 12 in which the wire 16 is disposed as above rotate together in the same direction and at the same speed, and the wire 16 wound around and hung on the main roller 12 accordingly runs at a predetermined speed.

Also, the first guide roller 20 includes a columnar core body 30 formed of a metal material, and a surface part 32 covering an outer circumferential surface of the core body 30. Similarly, the second guide roller 24 also includes a columnar core body 34 formed of a metal material, and a surface part 36 covering an outer circumferential surface of the core body 34. Also, in the surface parts 32 and 36, that is, the outer circumferential surfaces of the first guide roller 20 and the second guide roller 24, grooves are provided into which the wire 16 is inserted. When the wire 16 is inserted into this groove, a position of the wire 16 is determined at a predetermined position. This stabilizes the guiding of the wire 16 into the roller unit 10 and the guiding of the wire 16 out from the roller unit 10.

The above main roller 12, first guide roller 20 and second guide roller 24 include the surface parts 28, 32, and 36 formed by a resin material. This resin material is not particularly limited, and, for example, high density polyethylene, ultrahigh molecular weight polyethylene or the like is suitably used. Also, the surface parts 28, 32 and 36 may be formed by ceramics.

The above main roller 12, first guide roller 20 and second guide roller 24 have a structure that is not limited to the above structure, and the whole roller including a part corresponding to the core body may be formed of, for example, the material included in the above-described surface part, without using the columnar core body made of the metal.

Next, the wire 16 is an electric conductor, and a piano wire is generally used. As shown in FIG. 1, in the roller unit 10, the wire 16 wound across the pair of main rollers 12 and 12 as described above runs while being in contact with a power feed contact 42 of a power supply unit 40 disposed between the pair of main rollers 12 and 12. A voltage is supplied from the power supply device 90 to the power supply unit 40, and through the power feed contact 42 in contact with the wire 16, the supplied voltage is applied to the running wire 16 via the power feed contact 42.

Further, in the roller unit 10, a machining tank 44 that stores a machining liquid is disposed between the pair of main rollers 12 and 12. The machining liquid is a liquid having a predetermined electrical resistance value so that satisfactory electric discharge occurs only between the workpiece 80 and the wire 16 (an electric discharge generation part), the electric discharge generation part being filled with the liquid. Also, the machining liquid is a liquid also bearing a function of cooling an electric discharge machining part, removing shavings of the workpiece 80 or the like. An example of this machining liquid is water.

The wire 16 wound across the pair of main rollers 12 and 12 can run through the machining tank 44.

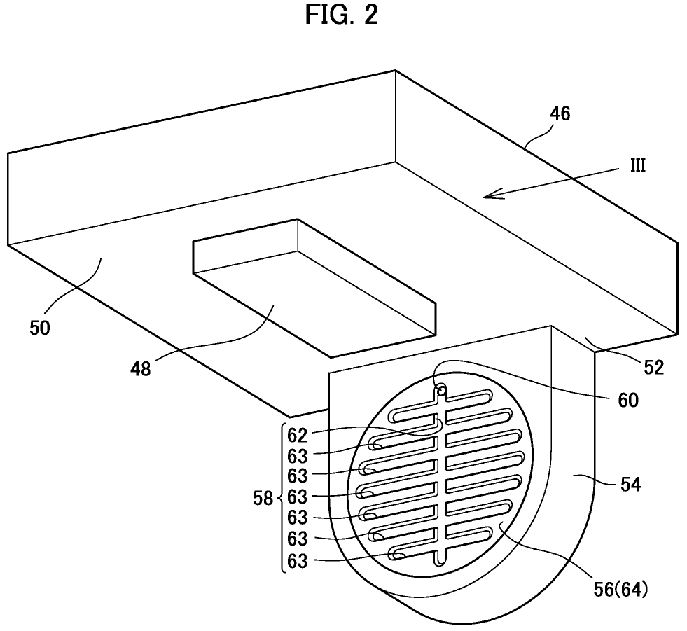

On the other hand, an elevating table 46 is disposed above the roller unit 10 between the pair of main rollers 12 and 12. The elevating table 46 can be raised and lowered with respect to the machining tank 44 by an elevating mechanism (not shown). There are not any special restrictions on a shape of the elevating table 46, and, for example, a rectangular plate-shaped member is used as shown in FIG. 2. Also, examples of a material of the elevating table 46 include stainless steel and aluminum.

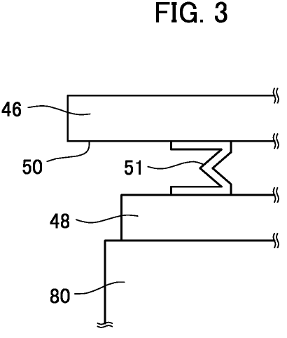

As shown in FIG. 2, an adhesive holding portion 48 is provided on a bottom surface 50 of the elevating table 46. As shown in FIG. 3, the adhesive holding portion 48 is disposed on the bottom surface 50 of the elevating table 46 via an energizing terminal 51. As shown in FIG. 3, the energizing terminal 51 is, for example, a member with a side view shape being an M-shape fallen laterally and is formed by machining a plate material made of a metal, having an elasticity and being excellent in conductivity. This energizing terminal 51 is electrically connected to the bottom surface 50 of the elevating table 46. The above-described adhesive holding portion 48 is a portion that adheres and holds the workpiece 80, and functions to hold the workpiece 80 so that it does not fall after the cutting process is completed. The adhesive holding portion 48 is formed of a material having conductivity and adhesiveness, for example, a conductive adhesive. Thus, since the adhesive holding portion 48 has conductivity and also has adhesiveness, the adhesive holding portion 48 can be electrically connected to the energizing terminal 51 on one hand and can hold the workpiece 80 while securing electrical connection on the other hand. Note that FIG. 3 also shows the workpiece 80.

Also, as shown in FIG. 2, the elevating table 46 has the one end portion 52 on which a jig 54 extending in a direction orthogonal to the bottom surface 50 is disposed. The jig 54 has a function of holding the workpiece 80 and a function of applying current from the workpiece 80.

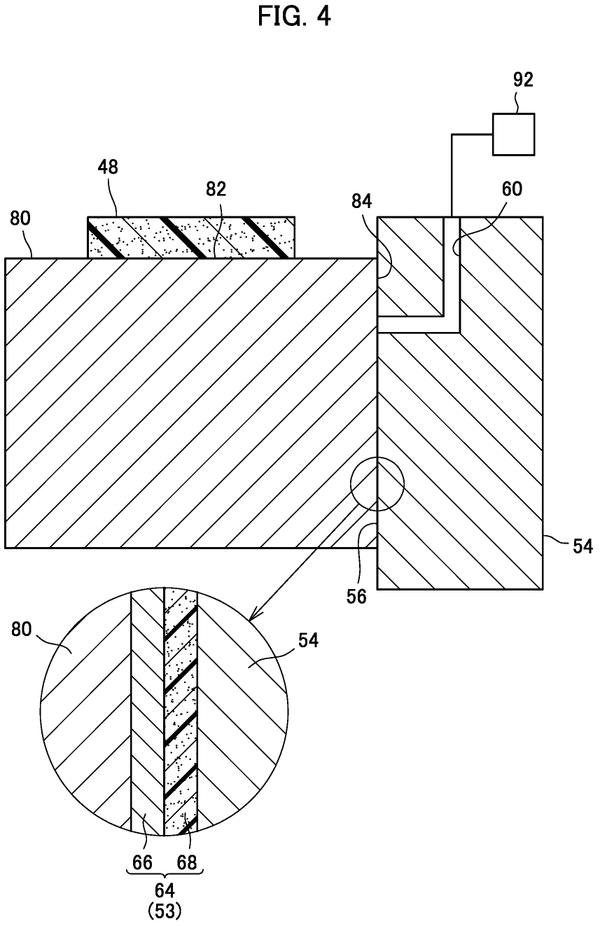

The workpiece 80 is, for example, a columnar ingot of SiC. As shown in FIG. 4, this ingot (workpiece 80) has a part 82 of an outer circumferential surface of the ingot adhered to the adhesive holding portion 48 and has one end portion 84 held by the jig 54.

Also, the function of holding the workpiece 80 in the jig 54 is brought by use of a suction force of a suction pump 92 in the present embodiment. Specifically, as shown in FIG. 2, the jig 54 includes a fixing part 56 that fixes one end portion 84 of the ingot (workpiece 80), and in the fixing part 56, a recessed groove 58 is provided. In a part of the recessed groove 58, a through hole 60 coupled to the suction pump 92 is provided. For example, as shown in FIG. 2, the recessed groove 58 has a shape including a main groove 62 extending in an up-down direction, and a plurality of branch grooves 63 extending in a direction orthogonal to the main groove 62. Note that there are not any special restrictions on a shape of the recessed groove 58, and a meandering curve shape, a radiating shape or the like may be adopted. Here, FIG. 2 shows one through hole 60 provided in the recessed groove 58. The jig 54 is not limited to this aspect, and an aspect where a plurality of through holes 60 are provided may be adopted. As the number of the through holes 60 increases, the suction force can more strongly and uniformly act on the workpiece 80.

As described above, one end portion 84 of the ingot (workpiece 80) is pressed onto the fixing part 56 of the jig 54 including the recessed groove 58, and in this state, the suction pump 92 is driven. Then, an interior of the recessed groove 58 is decompressed, with the decompression, the one end portion 84 of the ingot (workpiece 80) is suctioned, and the workpiece 80 is fixed to the jig 54.

In the present embodiment, in a part that faces the workpiece 80 and from which the recessed groove 58 is removed in the fixing part 56 of the jig 54, a cover layer 64 is disposed. The cover layer 64 is interposed between the jig 54 and the workpiece 80 and works to improve an adhesive property between the jig 54 and the workpiece 80, while securing conductivity.

For example, as shown in FIG. 4, the cover layer 64 is a composite that combines a copper foil 66 located on a workpiece 80 side and a conductive adhesive layer 68 located on a jig 54 side and has a sheet shape as a whole. Note that FIG. 4 does not show the recessed groove 58, the energizing terminal 51 and the elevating table 46.

Copper forming the copper foil 66 is excellent in conductivity and additionally has a comparatively soft property in the metal material. On the other hand, the conductive adhesive layer 68 includes a base material containing a resin material having adhesiveness, and a conductive filler dispersed in this base material. The cover layer 64 including the copper foil 66 and the conductive adhesive layer 68 is flexible and can therefore follow a shape of a gap or distortion between the jig 54 and the workpiece 80 if any. This can improve the adhesive property between the jig 54 and the workpiece 80. Therefore, even when the workpiece 80 is immersed into water in the machining tank 44, water can be prevented from permeating between the workpiece 80 and the jig 54. This contributes to suppression of occurrence of electrolytic corrosion. Also, a fine gap between the jig 54 and the workpiece 80 is filled with the copper foil 66 and the conductive adhesive layer 68, so that a satisfactorily energized state can be maintained, and occurrence of abnormal electric discharge can be suppressed. This contributes to suppression of generation of cracks in the workpiece 80 and generation of abnormal electric discharge marks in the jig 54.

When the cover layer 64 is a so-called copper foil conductive tape formed by combining the copper foil 66 and the conductive adhesive layer 68 as described above, the tape can be placed only by closely attaching the conductive adhesive layer 68 on the jig 54 side and is excellent in workability. Also, when the copper foil 66 is located on the workpiece 80 side, it is easy to remove the workpiece 80 after electric discharge machining, which contributes to improvement in work efficiency.

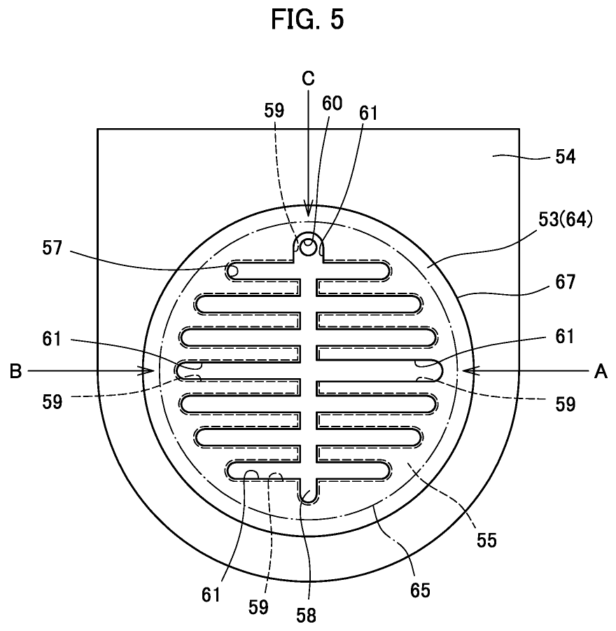

Also, a sheet 53 as the cover layer 64 disposed on the fixing part 56 of the jig 54 has a part overlapping with the recessed groove 58 removed. Specifically, as shown in FIG. 5, the sheet 53 has a part that faces the recessed groove 58 penetrating not to inhibit the suctioning of the workpiece 80. Here, it is preferable that an end portion 61 of a penetrating part (hereinafter referred to as a penetrating part 57) of the sheet 53 is removed completely along an edge 59 of the recessed groove 58, for example, as in a part shown with arrow A. However, the removal of the penetrating part 57 of the sheet 53 completely along the edge 59 of the recessed groove 58 takes time and labor, and hence the end portion 61 of the penetrating part 57 of the sheet 53 may exist on an inner side than the edge 59 of the recessed groove 58, for example, as in a part shown with arrow B as long as the suctioning of the workpiece 80 is not inhibited. That is, the sheet 53 has a region of the sheet 53 that overlaps with the recessed groove 58 (suction part) that is in a surface of the jig 54, and at least a part of the region is removed. Note that if the sheet 53 exists to overlap with a part corresponding to the through hole 60 coupled to the suction pump 92, there is concern that the sheet inhibits the suctioning. Therefore, it is preferable that the end portion 61 of the penetrating part 57 is removed completely along the edge 59 of the recessed groove 58 so that the sheet 53 does not overlap with the part of the through hole 60 as in a part shown with an arrow C.

Furthermore, it is preferable that an outer circumferential edge 67 of the sheet 53 is located on an outer side than an outer circumferential edge 65 of a part of the jig 54 that faces the workpiece 80. Here, description is made as to a relation between the sheet 53 and the part of the jig 54 that faces the workpiece 80 in more detail with reference to FIG. 5. FIG. 5 shows, with a virtual line, the part of the jig 54 that faces the workpiece 80, that is, a workpiece holding region 55 corresponding to the end portion of the workpiece 80. In the present embodiment, since the workpiece 80 is the columnar ingot of SiC, the workpiece holding region 55 is circular. The sheet 53 needs to secure the adhesive property between the workpiece 80 and the jig 54 so that water does not enter therebetween, and therefore preferably has a size to cover the whole workpiece holding region 55. Therefore, the outer circumferential edge 67 of the sheet 53 is located on the outer side than the outer circumferential edge 65 of the workpiece holding region 55. That is, it is preferable that a planar view shape of the sheet 53 is larger than a planar view shape of the part of the jig 54 that faces the workpiece 80.

Here, it is preferable that a thickness of the sheet 53 is 70 µm or less. If the thickness of the sheet 53 is in excess of 70 µm, defects might occur that an electrical resistance value between the workpiece 80 and the jig 54 increases and that temperatures of the workpiece 80, the sheet 53 and the jig 54 heighten. On the other hand, there are not any special restrictions on a lower limit value of the thickness of the sheet 53, but if the thickness is less than 20 µm, there is concern that flexibility of the sheet 53 lowers and the adhesive property between the workpiece 80 and the jig 54 is impaired. Consequently, it is preferable that the lower limit value of the thickness of the sheet 53 is 20 µm or more.

Note that the cover layer 64 is not limited to the composite of the copper foil 66 and the conductive adhesive layer 68 described above and may be a single layer of the copper foil 66. Also, the cover layer may be a single layer of the conductive adhesive layer 68. Further, the cover layer 64 is not limited to a sheet shape. For example, the part that faces the workpiece 80 and from which the recessed groove 58 is removed in the fixing part 56 of the jig 54 is coated with a mixture of the resin material having adhesiveness and the conductive filler, so that the cover layer 64 can be formed. Also, in the cover layer 64, in place of the copper foil that combines with the conductive adhesive layer 68, another metal foil excellent in conductivity, such as a gold foil, a silver foil or an aluminum foil, may be used. According to a further aspect, in the cover layer 64, a first conductive adhesive layer may be disposed on the jig 54 side, a second conductive adhesive layer may be disposed on the workpiece 80 side, and the copper foil 66 or another metal foil may be disposed between the first conductive adhesive layer and the second conductive adhesive layer.

Next, description will be made as to a procedure of using the wire electric discharge machining device 2.

First, a columnar ingot 80 of SiC as the workpiece 80 is set to the wire electric discharge machining device 2. Specifically, a part of an outer circumferential surface of the columnar ingot 80 is closely attached to the adhesive holding portion 48 on the bottom surface 50 of the elevating table 46, and the one end portion 84 of the columnar ingot 80 is pressed onto the jig 54. At this time, the cover layer 64 exists between the fixing part 56 of the jig 54 and the one end portion 84 of the columnar ingot 80. The cover layer 64 is the so-called copper foil conductive tape as described above in which the copper foil 66 and the conductive adhesive layer 68 are combined, the tape has a predetermined shape from which a part that overlaps with the recessed groove 58 in the fixing part 56 of the jig 54 is beforehand removed, and the tape is attached in place. In this state, the suction pump 92 is driven, and the ingot 80 is suctioned and fixed to the jig 54. Consequently, the ingot 80 adheres to the jig 54.

Next, the motor is driven, to rotate the main roller 12 in a predetermined direction. Consequently, the wire 16 runs at a high speed while passing through the machining liquid in the machining tank 44, between the pair of main rollers 12 and 12. At this time, the voltage is applied from the power supply unit 40 to the wire 16.

Next, the ingot 80 is gradually lowered together with the elevating table 46 and immersed into the machining liquid. Then, as the ingot 80 approaches the wire 16, electric discharge occurs between the wire 16 and the ingot 80, the ingot 80 is shaved from a bottom of the ingot, the cutting process proceeds, and the ingot 80 is divided into a plurality of slice products.

Here, during the cutting process, current passing through the ingot 80 flows into the adhesive holding portion 48 and the jig 54.

Thereafter, when the cutting process of the ingot 80 is completed and the ingot 80 is divided into the individual slice products, the running of the wire 16 and the lowering of the ingot 80 are stopped, respectively. Next, the applying of the voltage from the power supply unit 40 is stopped. Thereafter, the elevating table 46 is raised, and the slice products are taken out from the machining tank 44. At this time, the adhesive holding portion 48 prevents the slice products from falling apart. Subsequently, the respective slice products are taken away from the adhesive holding portion 48. Consequently, a plurality of desired slice products can be obtained. Thereafter, the suction pump 92 is stopped, and an interior of the recessed groove 58 is returned to atmospheric pressure. As a result, the sliced product closest to the jig 54 is removed.

The above-described operation is repeated, so that the slice products can be continuously manufactured.

The wire electric discharge machining device 2 according to the present invention includes the cover layer 64 in the part of the jig 54 that faces the workpiece 80, and the cover layer 64 has conductivity and also has an adhesive property to adhere to the workpiece 80 and the jig 54, so that the machining liquid (water) can be prevented from being interposed between the jig 54 and the workpiece 80. This can suppress occurrence of electrolytic corrosion. Also, the cover layer 64 can fill in a fine gap and distortion between the jig 54 and the workpiece 80, and hence occurrence of abnormal electric discharge can be suppressed. Consequently, generation of cracks in the workpiece 80 and generation of abnormal electric discharge marks in the jig can be suppressed. As a result, stable electric discharge machining is possible, and decrease in product yield and drop in operation rate can be prevented.

Also, the existence of the cover layer 64 improves a contact efficiency between the jig 54 and the workpiece 80 and increases an electric discharge machining capacity by about 15% than before.

Furthermore, conventionally, the jig 54 itself is consumable, and the jig 54 needs to be replaced after a work time of electric discharge machining reaches a predetermined value. According to the wire electric discharge machining device 2 of the present invention, however, the jig 54 itself can be repeatedly used only by replacing the cover layer 64, and replacement frequency of the jig 54 itself can be noticeably reduced.

Here, the present invention is not limited to the above embodiment and can be variously modified. For example, a method of holding the workpiece with the jig is not limited to a suction method, and a type of method of fixing the workpiece to the jig by use of a clamp may be adopted. Also, the main roller is not limited to a configuration of two axes that make a pair and may be a configuration of three or more axes. Further, the adhesive holding portion 48 may be an aspect of being directly connected to the bottom surface 50 of the elevating table 46, from which the energizing terminal 51 is omitted.

### Aspects of Invention

A first aspect of the present invention is directed to a wire electric discharge machining device which machines a workpiece by electric discharge between a wire and the workpiece, including a jig holding the workpiece, and a cover layer disposed in a part of the jig that faces the workpiece, and the cover layer has conductivity and also has an adhesive property to adhere to the workpiece and the jig.

According to this first aspect, existence of the cover layer fills in a gap between the workpiece and the jig and can therefore prevent permeation of water and suppress occurrence of abnormal electric discharge between the workpiece and the jig. Consequently, generation of cracks in the workpiece and generation of abnormal electric discharge marks in the jig can be suppressed, and as a result, decrease in product yield and drop in operation rate can be prevented.

A second aspect of the present invention is directed to the wire electric discharge machining device in the above-described first aspect of the present invention, wherein the cover layer contains a resin base material having adhesiveness, and a conductive filler dispersed in the resin base material.

According to this second aspect, conductivity and adhesive property can be easily exerted between the jig and the workpiece.

A third aspect of the present invention is directed to the wire electric discharge machining device in the above-described second aspect of the present invention, wherein the resin base material is formed in a sheet shape.

According to this third aspect, workability when placing the cover layer in the jig improves.

A fourth aspect of the present invention is directed to the wire electric discharge machining device in any one of the above-described first to third aspects of the present invention, wherein the cover layer contains a foil made of a metal and that faces the workpiece.

This fourth aspect can improve workability when taking the workpiece away from the jig while securing the conductivity.

A fifth aspect of the present invention is directed to the wire electric discharge machining device in the above-described fourth aspect of the present invention, wherein the foil is a foil made of any one of metals consisting of copper, silver, gold, and aluminum.

According to this fifth aspect, the foil made of any one of the metals consisting of copper, silver, gold, and aluminum is excellent in conductivity and can easily secure the conductivity between the jig and the workpiece. In particular, the foil made of copper is highly conductive, inexpensive and easy to obtain, so that cost required for replacement of the cover layer or the like can be reduced while maintaining the conductivity.

A sixth aspect of the present invention is directed to a sheet used in a wire electric discharge machining device which machines a workpiece by electric discharge between a wire and the workpiece, the sheet being put between the workpiece and a jig holding the workpiece, the sheet including a conductive layer formed of a metal material, and an adhesive layer containing a conductive material.

According to this sixth aspect, the sheet exerts excellent conductivity and adhesive property between the workpiece and the jig and contributes to suppression of occurrence of abnormal electric discharge between the workpiece and the jig.

A seventh aspect of the present invention is directed to the sheet in the above-described sixth aspect of the present invention, wherein in the conductive layer, the metal material is any one of copper, silver, gold, and aluminum.

According to this seventh aspect, these metals are excellent in conductivity and can easily secure the conductivity between the jig and the workpiece.

An eighth aspect of the present invention is directed to the sheet in the above-described sixth or seventh aspect of the present invention, wherein the jig includes a suction part that sticks the workpiece, the sheet including a region overlapping with the suction part that is in a surface of the jig, and at least a part of the region is removed.

According to this eighth aspect, when the workpiece is suctioned and held by the jig, the sheet is prevented from inhibiting the suctioning and can secure a satisfactory holding force.

A ninth aspect of the present invention is directed to the sheet in any one of the above-described sixth to eighth aspects of the present invention, wherein a thickness of the sheet is 70 µm or less.

This ninth aspect can shorten a distance between the workpiece and the jig and decrease an electrical resistance value between the workpiece and the jig.

A tenth aspect of the present invention is directed to the sheet in any one of the above-described sixth to ninth aspects of the present invention, wherein a planar view shape of the sheet is larger than a planar view shape of the part of the jig that faces the workpiece.

This tenth aspect can improve an adhesive property between the workpiece and the jig and prevent water from permeating between the workpiece and the jig.

### EXPLANATION OF REFERENCE SIGNS

2 wire electric discharge machining device
10 roller unit
12 main roller
14 wire reel
16 wire
20 first guide roller
24 second guide roller
40 power supply unit
42 power feed contact
44 machining tank
46 elevating table
48 adhesive holding portion
51 energizing terminal
53 sheet
54 jig
55 workpiece holding region
64 cover layer
66 copper foil
68 conductive adhesive layer
80 workpiece (ingot)

Although the present invention has been described with reference to preferred embodiments, workers skilled in the art will recognize that changes may be made in form and detail without departing from the spirit and scope of the invention.

1. A wire electric discharge machining device which machines a workpiece by electric discharge between a wire and the workpiece, comprising:
a jig holding the workpiece, and
a cover layer disposed in a part of the jig that faces the workpiece, wherein the cover layer has conductivity and also has an adhesive property to adhere to the workpiece and the jig.

2. The wire electric discharge machining device according to claim 1, wherein the cover layer contains a resin base material having adhesiveness, and a conductive filler dispersed in the resin base material.

3. The wire electric discharge machining device according to claim 2, wherein the resin base material is formed in a sheet shape.

4. The wire electric discharge machining device according to claim 1, wherein the cover layer contains a foil made of a metal and that faces the workpiece.

5. The wire electric discharge machining device according to claim 4, wherein the foil is a foil made of any one of metals consisting of copper, silver, gold, and aluminum.

6. A sheet used in a wire electric discharge machining device which machines a workpiece by electric discharge between a wire and the workpiece, the sheet being put between the workpiece and a jig holding the workpiece, the sheet comprising:
a conductive layer formed of a metal material, and
an adhesive layer containing a conductive material.

7. The sheet according to claim 6, wherein in the conductive layer, the metal material is any one of copper, silver, gold, and aluminum.

8. The sheet according to claim 6, wherein the jig includes a suction part that sticks the workpiece,
the sheet including:
a region overlapping with the suction part that is in a surface of the jig, wherein at least a part of the region is removed.

9. The sheet according to claim 6, wherein a thickness of the sheet is 70 µm or less.

10. The sheet according to claim 6, wherein a planar view shape of the sheet is larger than a planar view shape of the part of the jig that faces the workpiece.
